(19) United States
(12) Patent Application Publication
(10) Pub. No.: US 2010/0205024 A1
(43) Pub. Date: Aug. 12, 2010

(54) SYSTEM AND METHOD FOR APPLYING IN-DEPTH DATA MINING TOOLS FOR PARTICIPATING WEBSITES

(76) Inventors: HAGGAI SHACHAR, Tel Aviv (IL); Shahar Nechmad, Tel-Aviv (IL)

Correspondence Address: EDWARD LANGER;c/o SHIBOLETH YISRAELI ROBERTS ZISMAN & CO., 1 PENN PLAZA-SUITE 2527, NEW YORK, NY, 10119, US

(21) Appl. No.: 12/608,117

(22) Filed: Oct. 29, 2009

Related U.S. Application Data
(60) Provisional application No. 61/109,192, filed on Oct. 29, 2008.

(51) Int. Cl. G06Q 30/00; G06Q 10/00

(52) U.S. Cl. 705/7; 705/14.53; 705/14.43

(57) ABSTRACT

A method for enabling a Website to provide a ranking formula for data relevant to visitor activities. The method includes aggregating the data, monetizing the activity data and correlating the data, such that information is derived to enable a desired expansion of at least one designated activity. Another method is disclosed for managing an ad campaign for a Website based a visitor's previous activities. This second method includes analyzing a visitor's behavior resulting in observations such as that a visitor is a gadget-lover or is interested in babies' accessories. The method also includes tagging a visitor's profile with the respective observation, deciding by the Website as to the demographic factor to be targeted for an ad. For example, if the Website is selling chairs, people are located who are building new houses or who are interested in furnishings. Finally the most relevant ads are served to each visitor according to his profile.

### FIELD OF THE INVENTION

The present invention relates generally to Website measurement, and more particularly to a system and method for applying an in-depth analytical tool to Websites.

### BACKGROUND OF THE INVENTION

There are several methods of gathering information on visitors to Websites. One method uses the traffic history contained in the server's log files. They were not intended for monitoring Website traffic, although they can be used for this purpose. However the process of extracting the data from a busy server, collating it and presenting it to you is pretty slow and messy. Other systems make use of bits of HTML code added to the Web pages. These bits of code extract data from a Website visitor's browser and send it to a database on either the Web host's server or the proprietary server.

Overall Traffic Hit Counters typically provide:
Visitor Statistics;
Pages Visited;
Search Engines;
Keywords and Phrases; and
Browsers, cookies and other technical data

The basics and meaning of the information is typically presented in a summary page. The summary page should give an overview of the Website's progress during the selected time period. To be effective, it should also be compared to some previous time period of equal length. Usually, only tables of numbers for the current time period are presented. A better view is given by a stat service providing a rolling 30 day period report. One should look for the following information in the Summary Section:

Total number of pages visited;

Total number of visitors;

Number of New Visitors;

Number of Returning Visitors;

Number of Page Views per Hour; and

Average Amount of time spent on each page.

The Visitors Page should show the following:

Total Visitors;

New Visitors;

Returning Visitors;

Pages Per Visit;

Visits Per Day;

Average Time Per Visit; and

Visitor Detail Page.

All data should be tied to visitors, so one will know how they use and interact with the site. One should be able to see where each visitor came into the site, where they came from and where they went while they were there and how long they spent on each page. If there are many new visitors, but few returning visitors, then the site content probably needs to be made more appealing.

According to Wikipedia, Online Analytical Processing (OLAP) is a quick approach to provide answers to analytical queries that are multi-dimensional in nature. OLAP is part of the broader category of business intelligence, which also encompasses relational reporting and data mining. Databases configured for OLAP employ a multidimensional data model, allowing for complex analytical and ad-hoc queries with rapid execution time. The output of an OLAP query is typically displayed in a matrix format. The dimensions form the rows and columns of the matrix, which comprise the measures or values.

The core of an OLAP system is a concept of an OLAP cube (also called a multidimensional cube or a hypercube). It consists of numeric facts called measures which are categorized by dimensions. The cube metadata is typically created from a star schema or snowflake schema of tables in a relational database. Measures are derived from the records in the fact table and dimensions are derived from the dimension tables. Each measure can be thought of as having a set of labels, or meta-data associated with it. A dimension is what describes these labels; it provides information about the measure.

A simple example would be a cube that contains a store's sales as a measure, and Date/Time as a dimension. Each Sale has a Date/Time label that describes more about that sale. Any number of dimensions can be added to the structure such as Store, Cashier, or Customer by adding a column to the fact table. This allows an analyst to view the measures along any combination of the dimensions.

### For Example:

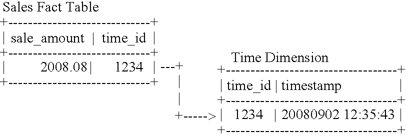

The most important time-saving mechanism in OLAP is the use of aggregations. Aggregations are built from the fact table by changing the granularity on specific dimensions and aggregating up data along these dimensions. The number of possible aggregations is determined by every possible combination of dimension granularities.

The combination of all possible aggregations and the base data contains the answers to every query which can be answered from the data. Due to the potentially large number of aggregations to be calculated, often only a predetermined number are fully calculated, while the remainder are solved on demand.

Engagement measures the extent to which a consumer has a meaningful brand experience when exposed to commercial advertising, sponsorship, television contact, or other experience. In March 2006, the Advertising Research Foundation (ARF) defined Engagement as “turning on a prospect to a brand idea enhanced by the surrounding context.” The ARF has also defined the function whereby engagement impacts a brand:

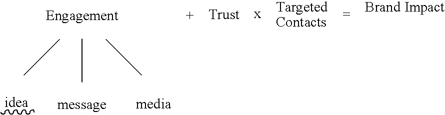

According to the TV Bureau of Canada, definitions of engagement can vary. Engagement boils down to the degree to which the creative content and media context of marketing communications results in meaningful communications with respect to the brand. A related metric is return on investment (ROI), which measures a sales payoff that can be attributed to specific marketing activity. Engagement metrics are quickly becoming favored by marketing executives, which is good news for TV media because television's sight-and-sound characteristics is ideal for creating a favorable environment for consumer engagement.

Engagement is most often measured by analyzing viewers' responses to various questions about a particular attitude toward media. Consumers rank their attitudes toward brands, for example, and indicate if they will recommend products to their circle of friends. Another way to test for engagement is to measure involuntary responses such as brain-wave activity and eye tracking during exposure to media.

Big marketers such as Procter & Gamble, Ford Motor Co., Microsoft, Revlon, and Time Warner are interested in engagement because audience fragmentation has created the need for more objective data to guide advertising spending across multi-media, cross-platform buys. The use of an engagement metric can give advertisers a tool to use to evaluate multiple media with the same yardstick.

Alan Wurtzel, NBC Universal president of research and media development recognizes the lack of standards in engagement measurement and has predicted that “everyone will have their own ‘secret sauce. “We understand there's a lot of customization.”

Media companies are presenting marketers with their own versions of engagement and cross-platform advertising metrics to lure ad spending, often using clever names to brand their latest innovations. NBC itself, will soon unveil its Total Audience Measure (TAMi) while MTV Networks is busy making the rounds talking up what it calls “return on innovation” a twist on well-used business term “investment.”

Nielsen executive vice president Susan Whiting says it is still early, and the data needs to be better integrated so that the media industry can easily connect various strands. “I see over the next two years a step to presenting information in combination. For example, how exposure on TV translates to activity on the internet.” Frank N. Magid Associates conducted Hearst-Argyle's Local Television Effectiveness Study, which illustrated that the news on local TV stations surpassed specialty and network news in terms of viewer trust, engagement and impression of advertisers.

Critics may argue that advertiser interest in engagement is a passing fad because it is an unstructured metric that is not easily defined. Furthermore, its mash up of advertising, programming and consumer response is complex and too subjective; viewing data is gathered from set-top boxes, portable devices to measure consumer media exposure out-of-home and the TV-viewing habits of users with digital video recorders (DVR's). In addition, some feel that engagement measurement will have a tough time replacing the current ratings metric, largely because different classes of advertisers have different goals. For example, retailing and consumer prices for automobiles, fast food, financial services, toothpaste, shoes, and drugs have little in common.

Engagement is complex because a variety of exposure and relationship factors affect engagement, making simplified rankings misleading. Typically, engagement with a medium often differs from engagement with advertising, according to an analysis conducted by the Magazine Publishers of America. Related to this notion is the term program engagement, which is the extent that consumers recall specific content after exposure to a program and advertising. Starting in 2006 U.S. broadcast networks began guaranteeing specific levels of program engagement to large corporate advertisers.

A critical companion metric to measuring audience size is pioneering a new way for advertising brands to target the most engaged and valuable audiences. Not all programming viewers are created equal and the value of television advertising grows as viewers connect with marketing messages across screens.

Following-up on its innovative Multi-Screen Engagement (MSE) case study of MTV's popular “The Hills” series, MTV Networks and Harris Interactive conducted industry-leading research across MTVN's brands, which provides empirical evidence that audiences develop stronger emotional connections to content and advertising messages when they consume and interact with them across multiple platforms. In total, more than 20,000 respondents between 13 and 49 participated in evaluating MTV Networks' programs, as well as competitive programs, networks and Websites along with a series of questions geared to defining a scalable and predictive engagement measurement model that, in effect, unlocks the value of engagement for marketers.

Specifically, this study reveals that some viewers are significantly, and even remarkably, more engaged with the content than others. These viewers with higher engagement are more likely to remember seeing an ad, internalize the message and be motivated by it to share more about the content and advertising with others when compared with those that are less engaged. This translates into increased purchase intent (up to two- and three-times) among viewers for brands that advertise in engagement-rich environments.

Thus it would be advantageous to provide means to go beyond traditional metrics, such as the page view, and instead provide structured measures of engagement.

### SUMMARY OF THE INVENTION

Accordingly, it is a principal object of the present invention to go beyond traditional metrics such as the page view and instead provide structured measurement of engagement.

It is one more principal object of the present invention to provide Website visitors with an individualized experience. One user should see more sports headlines while another is deeply engaged with the stock market. As the present invention analyzes everything at the user level, one can determine the interests of each visitor to the Website and provide a unique presentation of the Website to each visitor.

It is a further principal object of the present invention to enable Websites to measure visitor activities and interactions with more accuracy and depth.

It is another principal object of the present invention to provide a way to measure, understand and grow content, community and return-on-investment (ROI).

It is one other principal object of the present invention to enable Websites to determine how visitors interact with the various features of Websites.

It is yet a further principal object of the present invention to provide Websites with real-time alerts on site performance, trends, and abnormalities which are accompanied by actionable solutions.

A method is disclosed for enabling a Website to provide a ranking formula for data relevant to visitor activities. The method includes aggregating the data, monetizing the activity data and correlating the data, such that information is derived to enable a desired expansion of at least one designated activity. Monetizing the activity data also involves having a Website operator choose a unit of measure, such as dollars or seconds (the duration of a visitor's time performing a particular activity). Another method is disclosed for managing an ad campaign for a Website based a visitor's previous activities. This second method includes analyzing a visitor's behavior resulting in observations such as that a visitor is a gadget-lover or is interested in baby accessories. The method also includes tagging a visitor's profile with the respective observation and deciding by a Website operator as to the demographic factor to be targeted for an ad. For example, if the Website is selling chairs, people are located who are building new houses or who are interested in furnishings. Finally the most relevant ads are served to each visitor according to his profile and his ongoing Website activity.

The present invention provides an alert based system that analyzes the behavior of Website users, detects trends and abnormalities and points out meaningful changes on end users behavior. The application provides actionable reports, thus enables Websites to improve conversion rate and ROI, maximize engagement, time on site, etc.

Websites get real-time answers to questions such as:

How my site is doing right now?

Who are my top contributing writers?

Who are my top contributing users?

How do I attract the best users across the Web?

What is my top contributing content?

What users I'm about to lose?

What exact ROI do I get from each of my campaigns and site referrers?

Some of the unique features of the present invention are:

Measures the users' engagement and contribution parameters.

Discovers the exact contribution of every element of site content.

Goes deep into user level data.

Gets live alerts on changes in users' behavior.

The present invention provides a full two-way Application Programmer Interface (API). An API is the set of public methods a methodology presents to the world. In non-Java situations, API refers to the visible part of the code in a software package with which one interacts. Websites are able enhance users' site experiences using out of the box personalization and a recommendations engine. Websites can also develop incentives programs. Ad networks integrate with the API to serve different ads to specific users based on insights about that user. Publishers integrate with the API to dynamically program their site, even to the individual user level, based on insights into specific content that interests specific users. E-commerce platforms dynamically create specific offers and target specific products to specific users based on user behavior.

The present invention provides two basic tools:

### I Analytics Tool

Analyze Websites and provide feedback information about visitor activity.

Which products should get more effort?

Which search words should get more effort?

Each user can get a unique presentation of the Website, given enough information Which users should get more effort, e.g., send a greeting card, etc.

If one knows the utilization one can determine value of each actual end-user, e.g., “This user is worth $150.”

By running the ranking formula, one can give recommendations for any dimension:

users, products, search words, geographical location. E.g., a Web-surfing user came from Israel, was looking to purchase a product, i.e., a Kodak camera and used the search word SLR . . .

Users do not need anything to be installed or downloaded.

### II The Sage Data Mining Engine: Proactive Analytics

The tool (tradename “Sage”) provides a review of a Website's data to proactively apply analytical algorithms to derive interesting conclusions in the form of trends, spikes in behavior or other “stories.” For example, Website visitors from Jamaica may vary from day-to-day by about 3-4%, but yesterday there was a one day increase of 15%. In another example there was a steady increase of 34% of people looking for vacation places.

In another example, on a Website with a bidding format, a particular product was found to generate a disproportionately large amount of bids and reviews. It was recommended that that Website put the product on the home page. After appearing on the home page, daily sales for the product increased from dozens to hundreds.

The Website for the present invention may become a business partner with Websites or a business partner with consultants to Websites. The Website for the present invention analyzes data from a bidding Website such as Shopping.com and, as a result, may make recommendations based on visitors' behavior found from one product such as the iPhone to another product line such as Nokia. A recommendation may be made to display a message such as “many people who bought an iPhone also bought a Nokia phone.”

Such results are used to initiate and/or reformulate ads presented to visitors based on their previous activities, according the following exemplary procedure: analyzing a user's behavior results in observations that a user is a gadget-lover or is interested in baby accessories;

tagging the user's profile with the respective property;

deciding by the Website as to the demographic factor to be targeted for an ad, for example, if the Website is selling chairs the Sage engine finds people who are building new houses or people who are interested in furnishings (see “Top Engaging Tags,” with reference to FIG. 2 below); and

serving the most relevant ads to each user.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in which:

FIG. 1a is a schematic system block diagram of an exemplary method of the present invention;

FIG. 1b is a screenshot of a preferred embodiment of a Website showing the “Manage Ranking Formula” step in the Create New Formula mode of the Ranking Formula Wizard, constructed according to the principles of the present invention;

FIG. 1c is a screenshot of a preferred embodiment of a Website showing the “Naming” step in the Create New Formula mode of the Ranking Formula Wizard, constructed according to the principles of the present invention;

FIG. 1d is a screenshot of one embodiment of a Website showing the “Change values” step in the Ranking Formula Wizard, constructed according to the principles of the present invention;

FIG. 1e is a screenshot of a preferred embodiment of a Website showing the “Ranking Dashboard” on the Ranking Center HomePage, constructed according to the principles of the present invention;

FIG. 2a is a screenshot of the Activity Correlation Map, constructed according to the principles of the present invention;

FIG. 2b is a screenshot illustrating the ranking of the “Top Engaging Tags,” constructed according to the principles of the present invention;

FIG. 3 is a screenshot illustrating the ranking of the “Top Contributing Referrers, by Page Hits,” constructed according to the principles of the present invention;

FIG. 4 is a screenshot illustrating “Configure Alerts,” constructed according to the principles of the present invention;

FIG. 5 is a screenshot illustrating the analyses of the SAGE engine reports, constructed according to the principles of the present invention; and

FIG. 6 is a screenshot illustrating a SAGE engine synopsis report, constructed according to the principles of the present invention.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

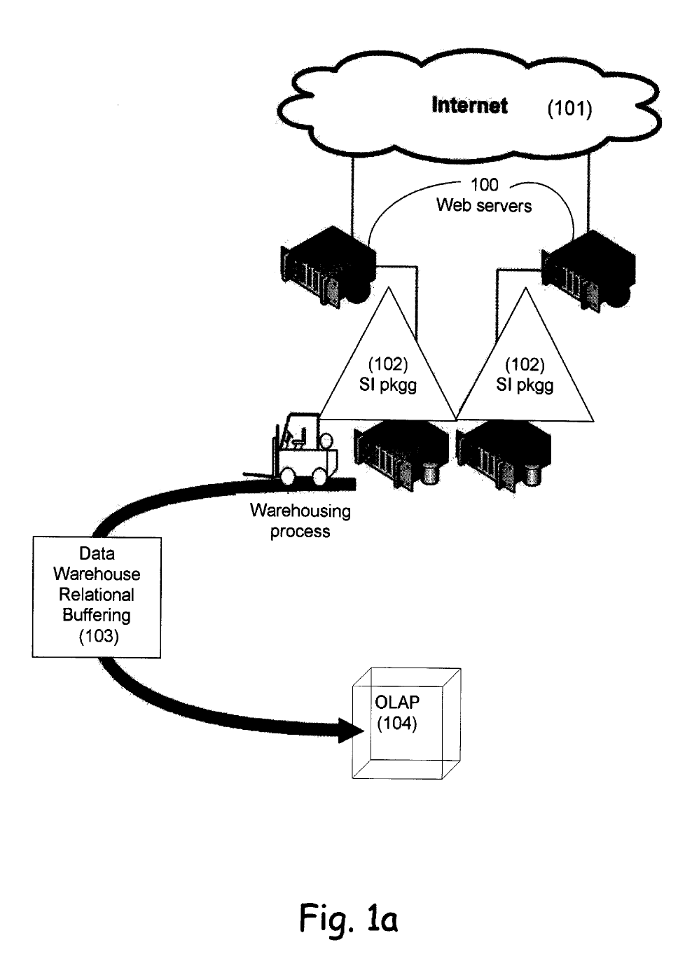

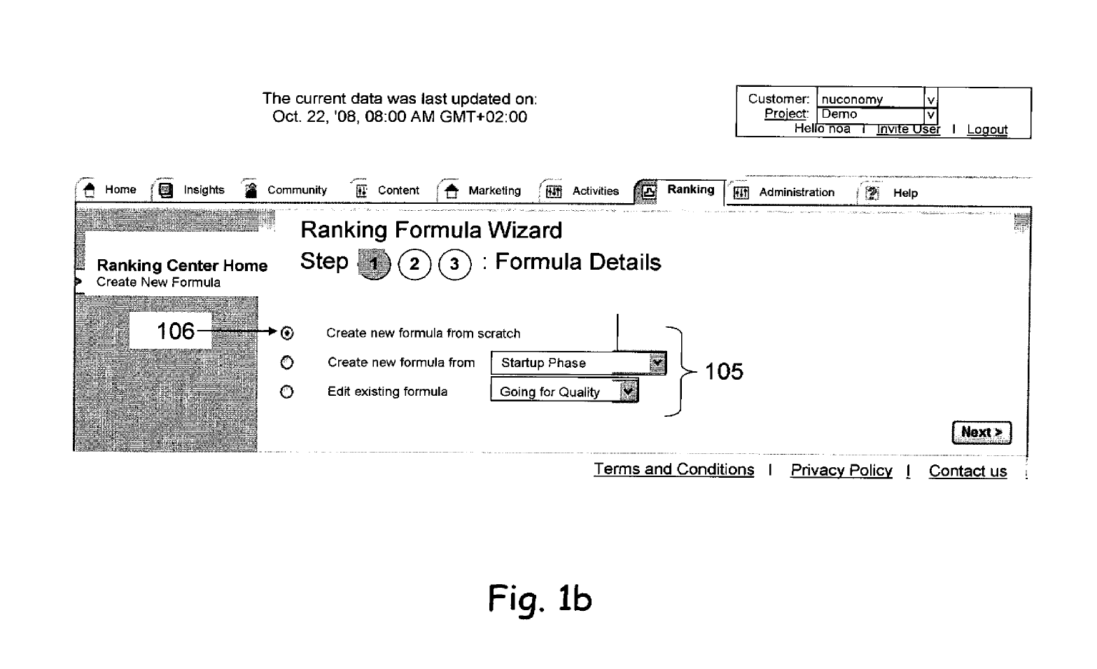

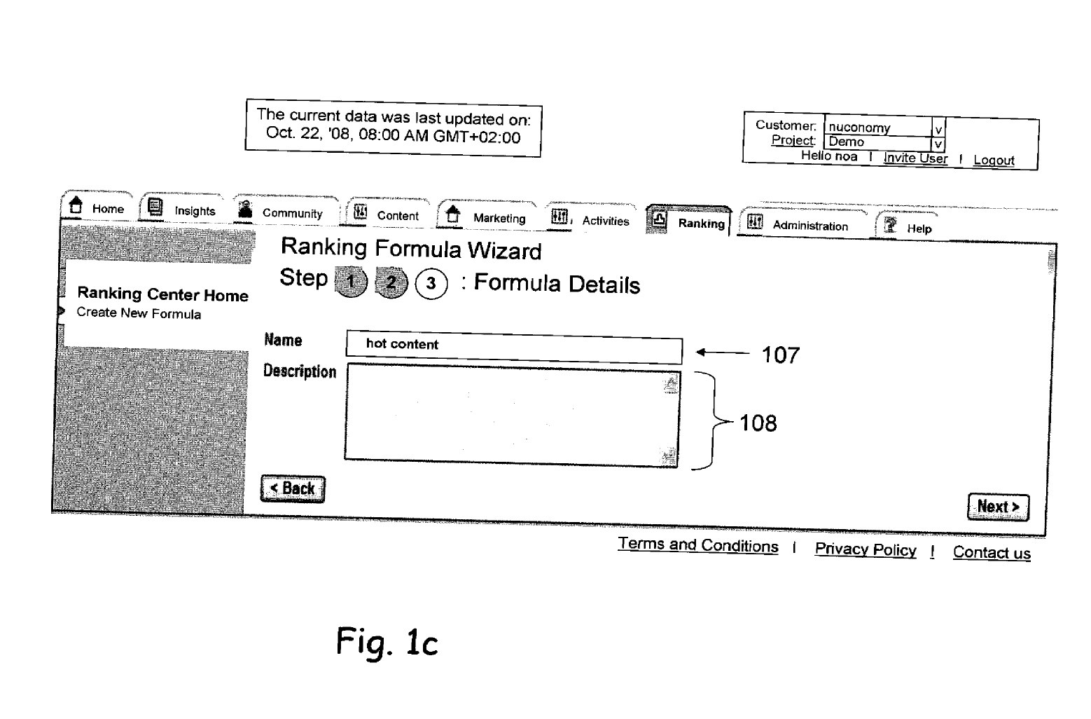

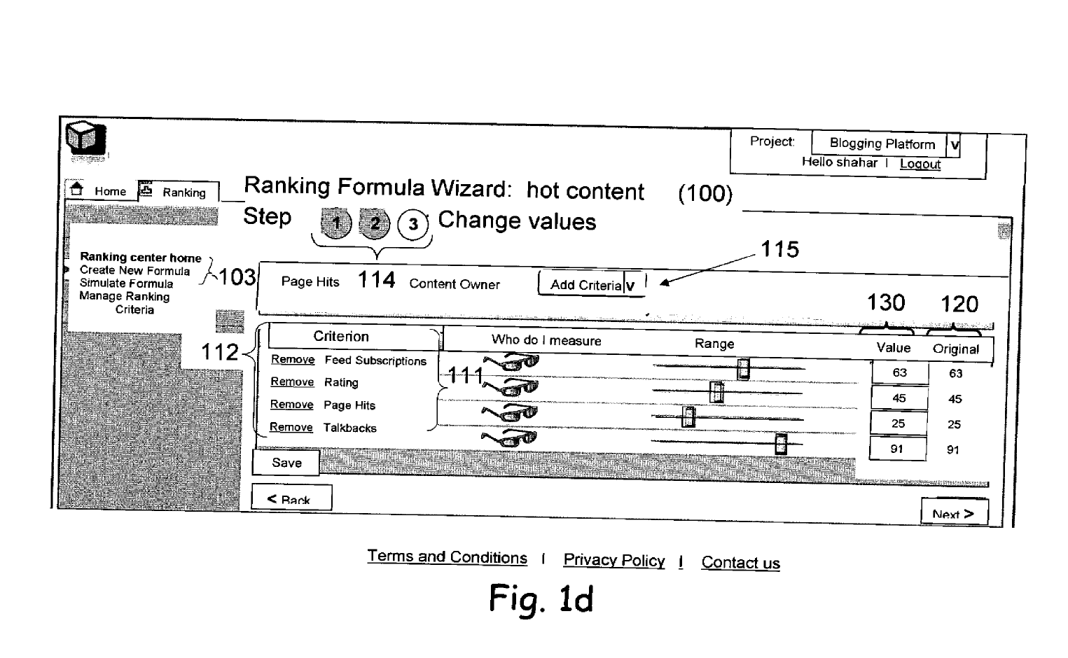

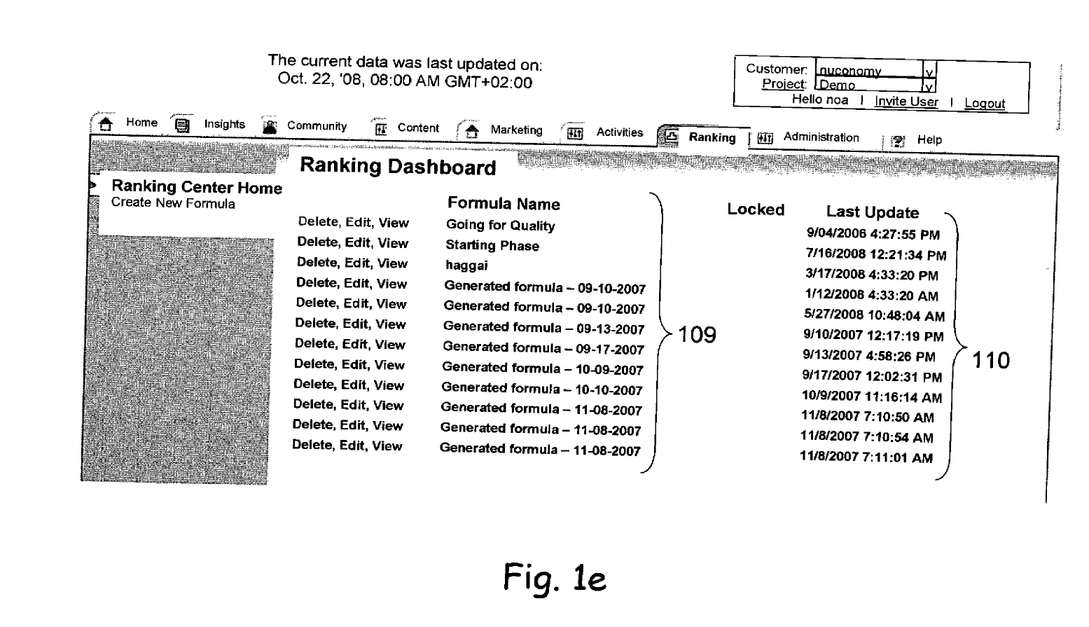

FIG. 1a is a schematic system block diagram of the method of the present invention. The Web server 100 receives ‘log-activity’ (LA) packets over the Internet 101 from all subscribing entitles. An LA packet contains the customer's identifier, a type of activity and its content, along with an arbitrary weight. System integration (SI) packaging 102 collects the LA packets into an XML file. The XML file is inserted to the relational database (DB).

SI is the process of creating a complex information system. This process may include designing or building a customized architecture or application, and integrating it with new or legacy hardware, packaged and custom software, and communications. The data warehouse 103 stores all activities in a relational database format that facilitates rapid access and retrieval by the Online Analytical Processing (OLAP) cube 104. OLAP cube 104 analysis engine facilitates rapid retrieval of multidimensional queries, providing insightful data regarding the customer's activities. The term “activity data,” as used herein, refers to visitor interactions with the Website.

### Ranking Formula

The idea of the ranking formula presumes that the information needed for the rankings is gathered over a period of a month.

Stage 1. As a first step, the activity data is aggregated.

Stage 2. The customer chooses an activity. Performing the activity creates input to be ranked. E.g., the activity may clicking on an advertisement, product purchase, amount of time the customer was in the system, etc. ENTER this information.

Monetization Activity (M.A.) After this, the customer chooses the unit of measure that he wants to use, such as dollars, seconds, etc. This is the only stage that is not operated automatically in the system. Rather, it is controlled by the customer.

FIG. 1b is an exemplary screenshot of a preferred embodiment of a Website showing the “Manage Ranking Formula” step in the Create New Formula mode of the Ranking Formula Wizard, constructed according to the principles of the present invention. There are 3 options 105 in the Manage Ranking Formula step:
“Create new formula from scratch”; 106 (this option is chosen in this example)
“Create new formula from” . . . a pull-down window lists various sub-options; and
“Edit existing formula” . . . a pull-down window lists various sub-options.

FIG. 1c is an exemplary screenshot of a preferred embodiment of a Website showing the “Naming” step in the Create New Formula mode of the Ranking Formula Wizard, constructed according to the principles of the present invention. The Naming step enables entry of a formula Name 107 and Description 108 in corresponding windows.

### Discover Who are the Websites' Best Reporters

FIG. 1d is an exemplary screenshot of one embodiment of a Website showing the “Change values” step 114 in Create New Formula Mode of the Ranking Formula Wizard, constructed according to the principles of the present invention. Ranking Formula Wizard 100 has two modes 103:
Ranking Center Home; and
Create a New Formula, which is shown in progress in Ranking Formula Wizard 100.

Change values step 114 is the 3^{rd} of three steps in creating a new formula.

The present invention can create any number of “contribution ranking formulas” using the User Interface (UI) of FIG. 1d. The original values for various criteria 120 can be replaced by changed values 130. Criteria 111 can be removed 112 or added 115.

FIG. 1e is a screenshot of a preferred embodiment of a Website showing the “Ranking Dashboard” on the Ranking Center HomePage, constructed according to the principles of the present invention. Substantially all the formulas that have been entered are listed by name 109 and date and time of the last update 110.

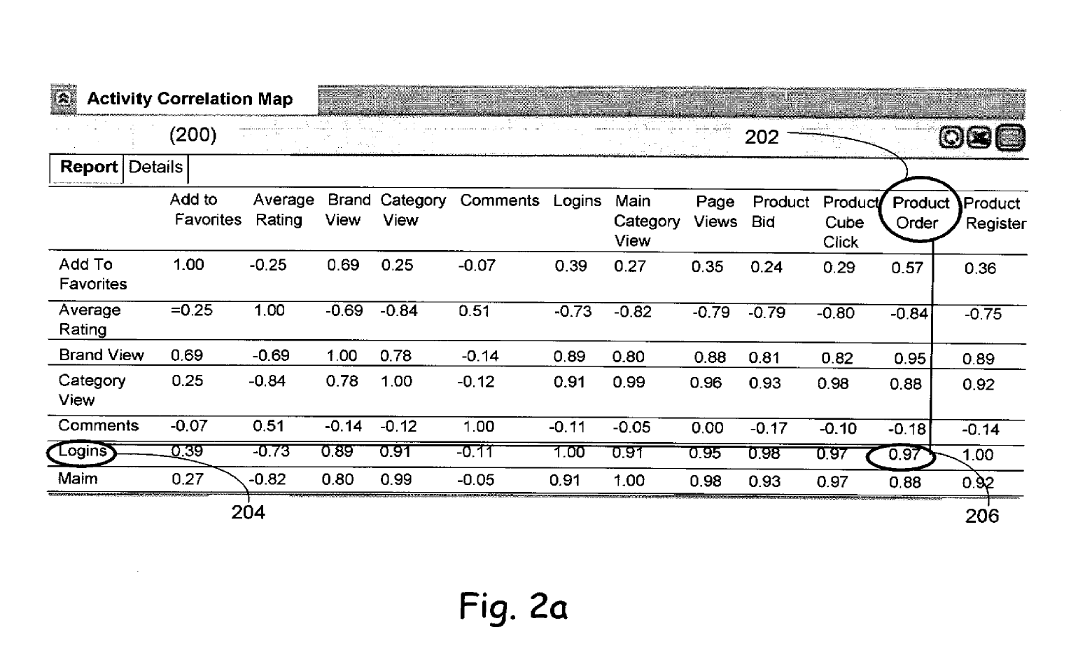

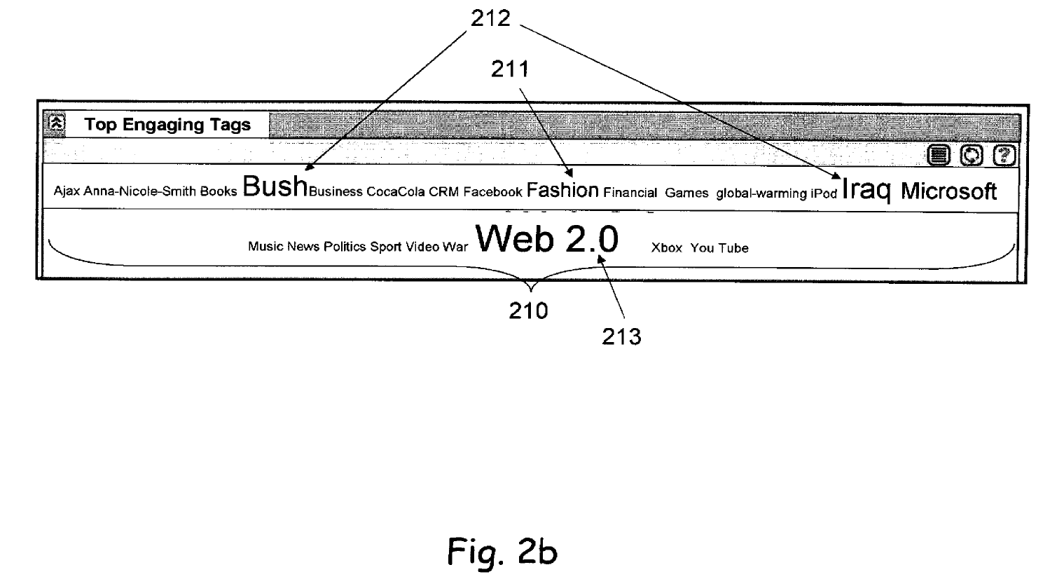

FIG. 2a is a screenshot of the Activity Correlation Map 200, constructed according to the principles of the present invention.

Stage 3. Correlation Matrix: At this stage, the system finds the correlation between the selected activity at stage 2 above and other activities in the system. In other words, the system finds graphical patterns identical to the behavior of a certain activity (for example, clicking on an advertisement) that was chosen. After the connection was found between the different graphs, a formalized ranking is created in the following manner: The connections are then organized between different activities in a table, according to the rank of the correlation strength between them.

Every activity receives its “score,” which encompasses the correlation between it and the activity that needs to be strengthened, such as clicking on an ad or buying a product. In the above mentioned table, for example, if the activity that one wants to expand is ordering a product, the action of subscribing to the system is an activity that would receive a high score at ranking the strength of the connection to ordering the product. In that case the score might be 97.

The correlation formula would be intercrossed with every other activity in the system. For example, if the client is a newspaper Website, it can measure the amount of income a certain journalist or department can be credited with over a specified period. This is derived from the number of clicks on an advertisement in that article that were written by a certain journalist or writer that appear in a specific department in the Website. If the client is a Website of electric appliances, it is possible to measure the amount of dollars made by the supplier by applying the ranking formula.

Activity Correlation Map 200, for example shows the correlation between Product Order 202 and Logins 204 to be 0.97, as indicated by reference block number 206.

### Discover the Websites' Top Contributing Content Elements

FIG. 2b is a screenshot illustrating the ranking of the “Top Engaging Tags,” constructed according to the principles of the present invention. What actually makes the Website business tick? Is it Sports? Is it fashion? Is it articles about Bush or the Nasdaq? With the present invention the Website can get a dynamic look at site content. Tags are keywords that describe the content of a Website, bookmark, photo or blog post. Tags help users search for relevant content. Tag-enabled Web services include social bookmarking sites, such as del.icio.us, photo sharing sites, such as Flickr and blog tracking sites such as Technorati. Tags provide a useful way of organizing, retrieving and discovering information. For example, a blog entry on the Green Bay Packers might be given the tags of “blog,” “Green Bay,” “Packers,” and “football.” Tag can also be used as a verb, as in tagging a blog entry or searching for articles tagged with “sports.” A tag cloud is a box containing a list of tags with the most prominent or popular tags receiving a darker and bigger font than less popular tags.

A Website can determine the contribution of different tag contents using the contribution ranking formulas created in conjunction with FIG. 1 above. Alternatively, the Website can determine specific criteria, such as what content element generated the most comments or the most Clicks on ads? Thus, in FIG. 2, a tag cloud 210 is shown for a typical Website. The tag

“Web 2.0” has the largest font 213. The tags “bush” and “Iraq” have an intermediate font 212. The tag “fashion” has the least enlarged font 211.

### Understand the Exact Contribution of Your Campaigns or Site Referrers

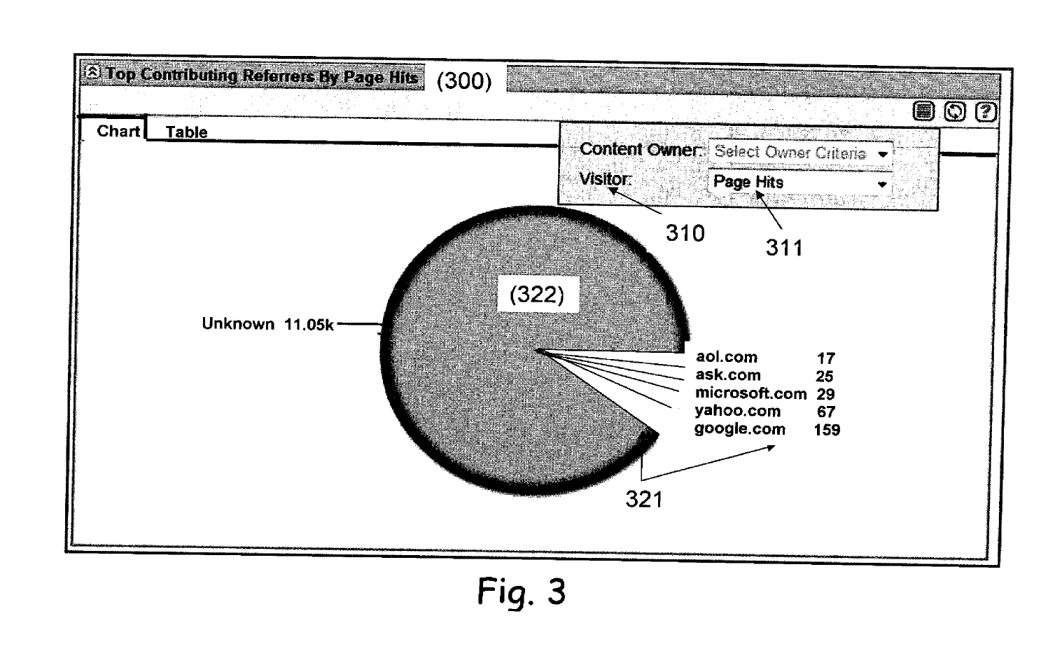

FIG. 3 is a screenshot illustrating the ranking of the “Top Contributing Referrers by Page Hits 300,” constructed according to the principles of the present invention. If one campaign brought one million people to the Website and a second just half a million, does it means that the first campaign had a better ROI? What if the second campaign actually brought twice as many people who registered to the Website as the first campaign? Perhaps the people who got to the Website from the second campaign generated twice as many clicks on ads? Or comments? With the present invention one can understand the exact ROI from each campaign or from specific site referrers. Thus, in FIG. 3 the selected criterion for visitors 310 is page hits 311. The top referrer shown is google.com 321 with 159 referrals. The vast majority are unknown 322.

Discover the Users the Website is about to Lose Before it Actually Happens

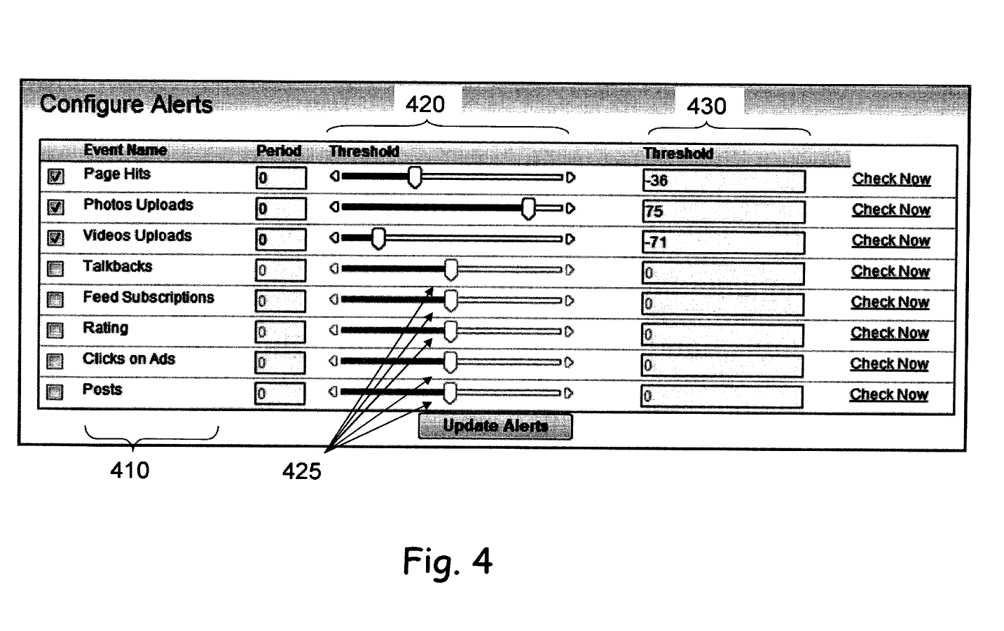

FIG. 4 is a screenshot illustrating Configure Alerts, constructed according to the principles of the present invention. Some of the users are going to lose interest in the Website over time. The Website would want to know this before it happens in order to target them with a marketing message and gain their loyalty back. With the present invention one can define alerts on changes in users' behavior corresponding to defined event types 410. If a user previously read the Website every morning and suddenly he started to do so just once a week, this is a red alert for the site. Thresholds for each event type can be adjusted by a slider 420, with the default middle position 425 corresponding to a zero threshold. The numerical value 430, in a plus or minus value is also shown.

Determine which is the Website's Hot Content

How does one determine what content to push to the home page of the Website or each section? How does one know which content will contribute the most to the business model? The present invention can determine the exact contribution of each content element in the Website, whether it's articles, photos or videos.

As every feature of the present invention is presented in two easy to use aspects of the 2-way application programmer interface (API), which enables visitor interaction, one can take this information and embed it back into the Website as a hot content list.

### No Two Users are the Same

The present invention enables giving Website visitors a personal experience. One user should see more sports headlines while another is deeply engaged with the stock market. As the present invention analyzes everything at the user level, one can determine the interests of each visitor to the Website.

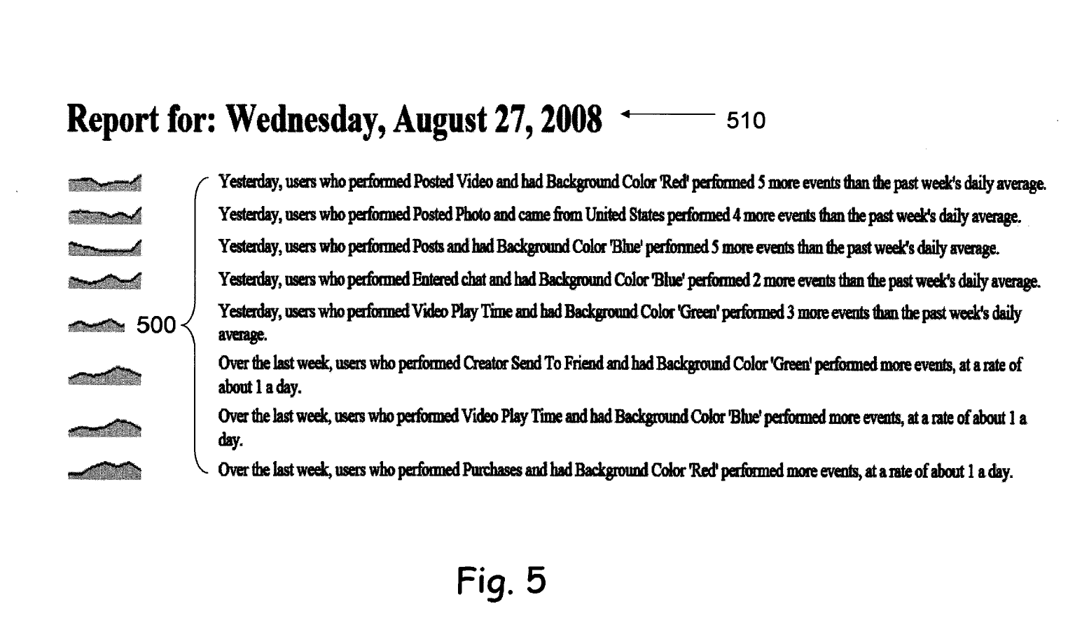

FIG. 5 is a screenshot illustrating the analyses of the SAGE engine, constructed according to the principles of the present invention. SAGE is an engine that runs algorithms on all the system data over intervals of time. The algorithms search three types of anomalies in the system's accumulated data. The data is processed for daily, weekly, monthly, quarterly and yearly analyses as follows:

a. Increases/linear changes in the data after some time (a period of one day, week, month, quarter or year) 500. FIG. 5 shows a report for a particular day 510.

b. Specific peaks in the data: the algorithm executes various cuts (today's data against last week's data, this week against last month, etc.) and searches marginal material that exceeds the defined limit of the listed item time period being evaluated.

c. Exponential changes in activity data are detected during the period in comparison with similar previous subcategories.

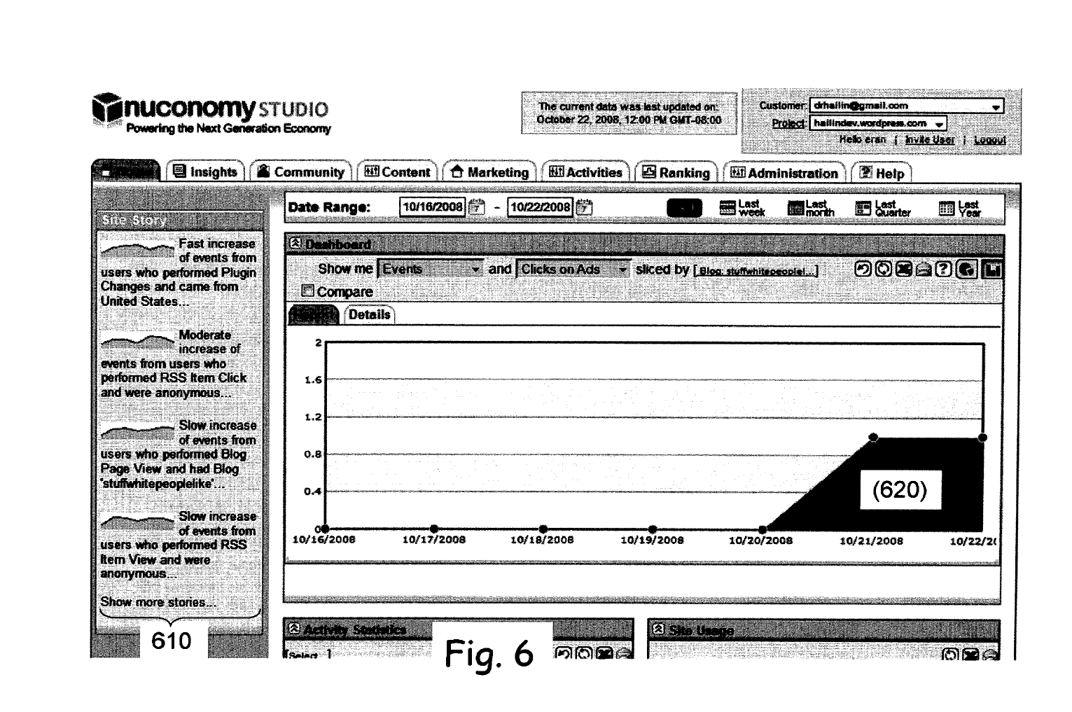

FIG. 6 is a screenshot illustrating a SAGE engine synopsis report, constructed according to the principles of the present invention. “Site Stories” 610 based on specific anomalies in the Website's activity data are presented. A graphic illustration of a specific anomaly 620 is shown.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method for enabling an advertising Website to provide a ranking formula for data relevant to visitor activities performed at the Website, said method comprising:
aggregating said activity data, said aggregating comprising:
choosing a procedure by a Website operator, which clusters said activity data, said activity data comprising at least one of:
clicks indicating visitor general behavior relative to an advertisement of the Website;
clicks on an advertisement;
clicks for receiving product purchase information;
clicks representing the amount of time the visitor was at the Website and the advertisement was in view;
clicks representing posted comments on a particular advertised product or service; and
clicks representing recommendations posted to friends; and
entering said activity data;
monetizing said activity data wherein said Website operator chooses a unit of measure comprising one of at least dollars and seconds; and
correlating the data, said correlating comprising at least one of:
finding correlations for chosen activity data;
finding at least one graph similar to the graph of a particular chosen activity data; and
establishing the correlation of said at least one graph found;
creating a ranking formula; and
forming a series of correlations between a number of said activities according to the degree of strength of the correlations,
such that information is derived to enable a desired expansion of said at least one chosen activity.

2. A method for managing an ad campaign for a Website based on a visitor's previous activities, said method comprising:
analyzing a visitor's behavior;
tagging the profile of each visitor with the respective observation of said visitor's behavior;
deciding by a Website operator on a demographic factor to be targeted for an ad; and
serving the most relevant ads to each visitor.

3. The method of claim 2, further comprising providing actionable reports enabling Websites to improve at least one of conversion rate, ROI, engagement and time on site.

4. The method of claim 2, further comprising detecting trends and anomalies.

5. The method of claim 4 said method further comprising compiling actionable reports based on trends and anomalies.

6. The method of claim 2, further comprising developing a ranking formula.

7. The method of claim 2, wherein said analyzing results in observations that a user has tendencies such as he/she is a gadget-lover or is interested in babies' accessories.

8. The method of claim 4, wherein said detecting trends and anomalies further comprises coordinating with at least one of Flash, AJAX, and Silverlight applications.

9. The method of claim 2 wherein said serving further comprises reformulating a current advertisement on the Website in light of said visitor's behavior.

10. A system for managing an ad campaign for a Website based on a visitor's previous activities, said system comprising:
a 2-way application programmer interface (API) enabling visitor interaction;
a Web server to receive log activity (LA) packets from all subscribing entities, said LA packets comprising visitor's ID, activity type and content and an arbitrary weight;
at least one packaging module to collect said LA packets into an XML file for insertion in a relational database;
a data warehouse to format and store all activity information for rapid access and retrieval by an Online Analytical Processing (OLAP) cube of an OLAP engine; and
an OLAP engine to provide quick insightful answers to multi-dimensional analytical queries about visitor activities,
thereby enabling the Website to be alert-based, dynamic and automatically changed based on current metrics and insights, in turn based on one of at least the ability to show ads and push specific content relevant to a visitor's interests.

11. The system of claim 10, further comprising means for providing actionable reports enabling Websites to improve at least one of conversion rate, ROI, engagement and time on site.

12. The system of claim 10, further comprising means for detecting trends and anomalies.

13. The system of claim 12 said method further comprising means for compiling actionable reports based on trends and anomalies.

14. The system of claim 10, further comprising means for developing a ranking formula.

15. The system of claim 10, wherein said OLAP engine provides observations that a user has tendencies such as he/she is a gadget-lover or is interested in baby accessories.

16. The system of claim 12, wherein said means for detecting trends and anomalies coordinates with at least one of Flash, AJAX, and Silverlight applications.
